(19) United States
(12) Patent Application Publication
(10) Pub. No.: US 2026/0364751 A1
(43) Pub. Date: Nov. 19, 2026

(54) GEARLESS SOCKET WRENCH

(71) Applicant: Thomas Godfroy, Huntsville, AL (US)

(72) Inventor: Thomas Godfroy, Huntsville, AL (US)

(21) Appl. No.: 19/211,825

(22) Filed: May 19, 2025

(51) Int. Cl. B25B 13/46; B25B 13/48; B25B 23/00

(52) U.S. Cl. CPC B25B 13/462; B25B 23/0035; B25B 13/481

(57) ABSTRACT

A gearless socket wrench that has a head unitary with a handle and a selector contained in the head for changing a drive direction, the selector remaining fixed when a fastener is being tightened. Further, the wrench has a collector that moves relative to the fixed selector when the fastener is being tightened and a drive selection mechanism that, when actuated, engages the selector to change the drive direction.

### BACKGROUND

Conventional socket wrenches typically feature reversible one-way drive systems that rely on an internal ratchet mechanism, such as a ring of teeth and engaging pawls, to transfer torque from the handle to a socket. These designs require a minimum angular rotation of the handle to reposition the pawls, restricting their utility in confined spaces where such movement is limited. Additionally, these wrenches produce a characteristic ratcheting sound during operation, providing auditory feedback to the user. More recent developments include gearless socket wrenches, which employ a roller-based, reversible drive mechanism to convert reciprocating handle motion into rotational output. These tools eliminate the need for gears by using components like ramps and rollers, enabling operation with variable handle strokes suitable for tight spaces. However, such gearless designs often lack the auditory feedback of traditional wrenches and may require direct multi-finger or multi-hand adjustment of drive elements to change drive direction, potentially complicating use. Existing reversable gearless wrenches also commonly feature open-ended handle structures, which can affect manufacturability, assembly, functionality, ergonomics, or aesthetics.

### DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, reference numerals designate corresponding parts throughout the several views.

FIG. 1A is an exploded view of a gearless socket wrench having no socket release in accordance with an embodiment of the present disclosure.

FIG. 1B is a top view of the gearless socket wrench shown in FIG. 1A.

FIG. 2A is an exploded view of a gearless socket wrench having a socket release in accordance with an embodiment of the present disclosure.

FIG. 2B is a top view of the gearless socket wrench shown in FIG. 2A.

FIG. 3A is a cross-sectional view of a sector and collector engaged showing a counterclockwise direction of the socket wrench shown in FIG. 1A.

FIG. 3B is a cross-sectional view of a sector and collector engaged showing a clockwise direction of the socket wrench shown in FIG. 1A.

FIG. 4 is an exploded view of the gearless wrench of FIG. 1A showing an exemplary lever used for drive selection.

FIG. 5 is an exploded view of the gearless wrench of FIG. 1A showing an exemplary button used for drive selection.

### DETAILED DESCRIPTION

This present disclosure is a gearless socket wrench that provides reversible one-way drive with variable handle strokes, enhanced ergonomics, simplified manufacturability, and assembly featuring a sealed flat-back handle, lever, button, switch, or dial drive direction change, push button socket release, and auditory feedback through a ratcheting sound. The following description details the structure and operation of the wrench, including its interchangeable lever or button-actuated mechanism.

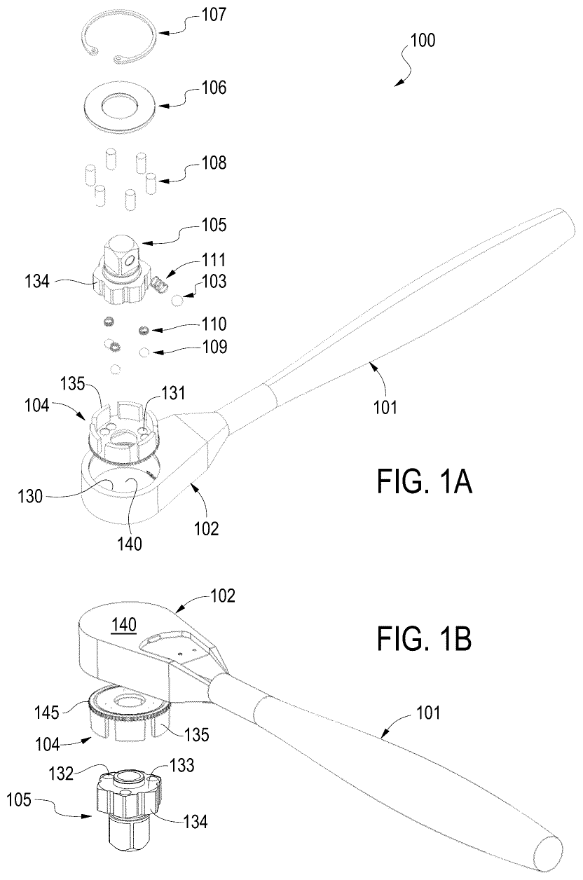

FIG. 1A is a bottom exploded view of the gearless socket wrench 100 without a socket release in accordance with an embodiment of the present disclosure. The gearless socket wrench 100 comprises a handle 101 and a head 102. The head 102 can be integrated with the handle 101 or could be able to pivot on the handle 101. In this regard, the head 102 and the handle 101 may be a monolithic structure. Within the head 102 is an aperture 130 in which a selector 104, collector 105, balls 109 and springs 110, socket retention spring 111 and ball 103, rollers 108, and washer 106 are placed and retained by clip 107. Note that while socket retention spring 111 is shown, other socket retention mechanisms may be used in other embodiments. The selector 104 when actuated changes drive direction, and the selector 104 may be actuated via a button or lever, as described further herein or other methods such as a switch (not shown) or dial (not shown). In this regard, the selector 104 changes direction of ratcheting to allow a user to tighten or loosen a fastener (not shown) via a socket (not shown) engaged with the socket wrench 100.

In one embodiment, the selector 104 comprises a set of fingers 135 around a periphery of the selector 104. When engaged by a drive selection mechanism, as described herein, the direction of rotation of the socket wrench 100 may be selected to loosen or tighten the fastener via the socket engaged with the socket wrench 100. The selector 104 forms an opening in which a collector 105 is placed and retained. In this regard, the collector 105 is a force transmission member that transmits torque to the fastener in coordination with the selector 104 and rollers 108. In one embodiment, the collector 105 employs ramps 134 in coordination with rollers 108 to transmit torque gearlessly.

FIG. 1B shows a top side exploded view of the socket wrench 100. A plurality of spring-operated balls 109 fit within openings 132 in a surface 133 of the collector 105, which interface with springs 110 during operation. The balls 109 provide means for movement of the selector 104 when actuated and drive direction positioning via openings in the selector 131, reference FIG. 1A. In this regard, when actuated, the selector 104 moves relative to the collector 105, which remains fixed during operation.

Further, one or more rollers 108 are situated around the collector on ramps 134. And when assembled, the rollers 108 protrude from between rectangular fingers 135 in the selector 104.

In use, reciprocating arcuate motion of the handle 101 drives the rollers 108 along the collector's ramps 134, locking the collector 105 to handle 101 for rotation in the selected direction (e.g., clockwise) while allowing free return on the backstroke.

In the embodiment shown in FIG. 1A and FIG. 1B, there is no socket release. In such an embodiment, the side of the head 102 opposing aperture 130 is a solid, closed plate 140. The flat rear surface remains stationary, improving control and ergonomics by allowing downward pressure to be applied to wrench during use on surface 140 (such as from hand pressure) without causing an undesired direction change.

The socket wrench 100 comprises the handle 101 and the head 102. In the embodiment shown, the socket wrench 100 does not have a socket release. As such, the top side of the head 102 comprises the solid, closed plate 140.

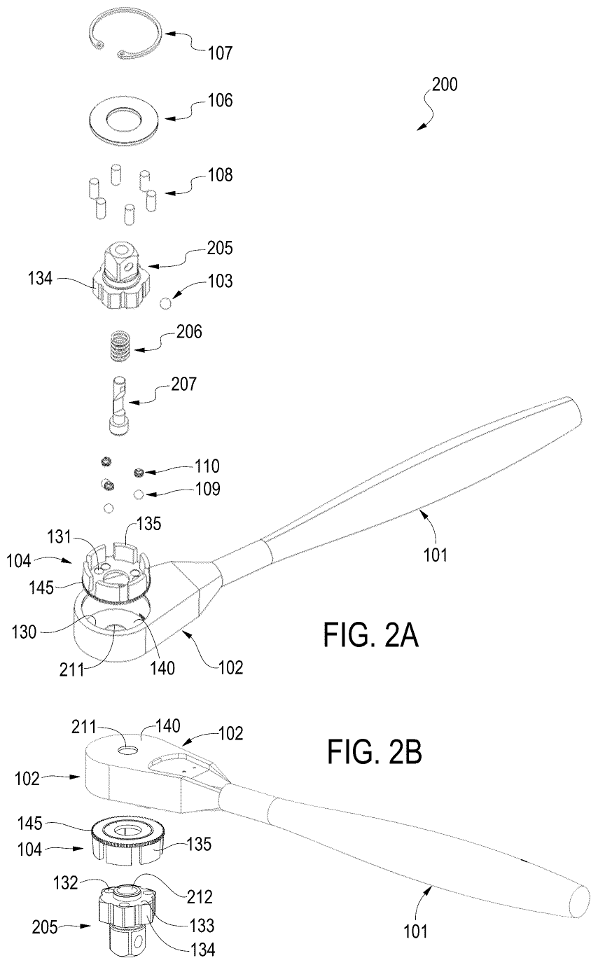

FIG. 2A is a bottom exploded view of the gearless socket wrench 200 with socket release in accordance with an embodiment of the present disclosure. The gearless socket wrench 200 comprises the handle 101 and a head 102. The head 102 can be integrated into the handle 101 or could be able to pivot on the handle 101. In this regard, the head 102 and the handle 101 may be a monolithic structure. Within the head 102 is an aperture 130 in which a selector 104, collector 205, balls 109 and springs 110, socket release pin 207, socket release spring 206, socket retention ball 103, rollers 108, and washer 106 are placed and retained by clip 107. The selector 104 when actuated changes drive direction, and the selector 104 may be actuated via a button or lever as described further herein or other methods such as a switch (not shown) or dial (not shown). In this regard, the selector 104 changes direction of ratcheting to allow a user to tighten or loosen a fastener (not shown) via a socket (not shown) engaged with the socket wrench 200.

In one embodiment, the selector 104 comprises a set of fingers 135 around a periphery of the selector 104. When engaged by a drive selection mechanism, as described herein, the direction of rotation of the socket wrench 200 may be selected to loosen or tighten the fastener via the socket engaged with the socket wrench 200. The selector 104 forms an opening in which a collector 205 is placed and retained. In this regard, the collector 205 is a force transmission member that transmits torque to the fastener in coordination with the selector 104 and rollers 108. In one embodiment, the collector 205 employs ramps 134 in coordination with rollers 108 to transmit torque gearlessly.

FIG. 2B shows a top side exploded view of the socket wrench 200. A plurality of spring-operated balls 109 fit within openings 132 in a surface 133 of the collector 205, which interface with springs 110 during operation. The balls 109 provide a means for movement of the selector 104 when actuated and drive direction positioning via openings in the selector 131, reference FIG. 2A. In this regard, when actuated, the selector 104 moves relative to the collector 205, which remains fixed during operation.

Further, one or more rollers 108 are situated around the collector on ramps 134. And when assembled, the rollers 108 protrude from rectangular fingers 135 in the selector 104.

In use, reciprocating arcuate motion of the handle 101 drives the rollers 108 along the collector's ramps 134, locking the collector 105 to handle 101 for rotation in the selected direction (e.g., clockwise) while allowing free return on the backstroke.

The gearless socket wrench 200 is like components and functionality as the gearless socket wrench 100. However, the gearless socket wrench 200 further comprises a socket release pin 207, reference FIG. 1A, that is spring-loaded with spring 206, reference FIG. 1A.

The socket release pin 207, reference FIG. 1A, extends through opening 212 in the collector 205. A button-end of the socket release pin 207, reference FIG. 1A. protrudes from the head 102 through opening 211 in surface 140 in the head 102. The socket release pin 207, reference FIG. 1A, provides rapid socket detachment.

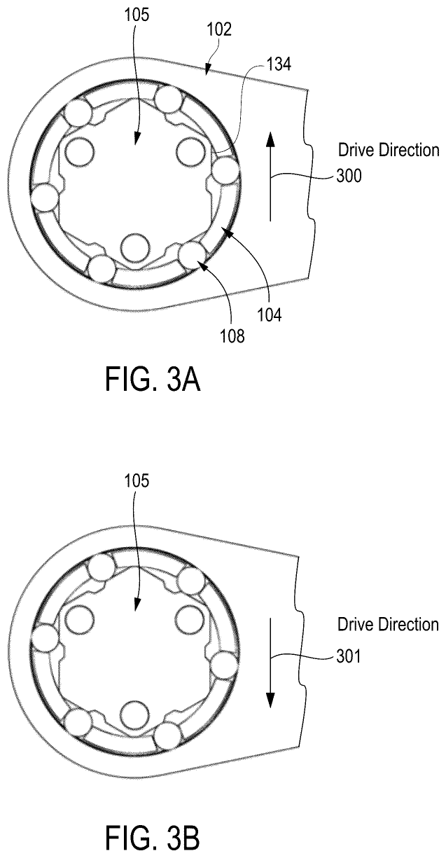

FIGS. 3A and 3B are diagrams showing drive directions related to roller positions. In this regard, when the selector is actuated as shown in FIG. 3A, the selector 104 moves relative to the fixed collector 105, placing the rollers 108 in position so that when the handle is rotated, the drive direction is shown by reference arrow 300. Whereas, in FIG. 3B, the selector 104 moves relative to the fixed collector 105, placing the rollers 108 in position so that when the handle is rotated, the drive direction is shown by reference arrow 301.

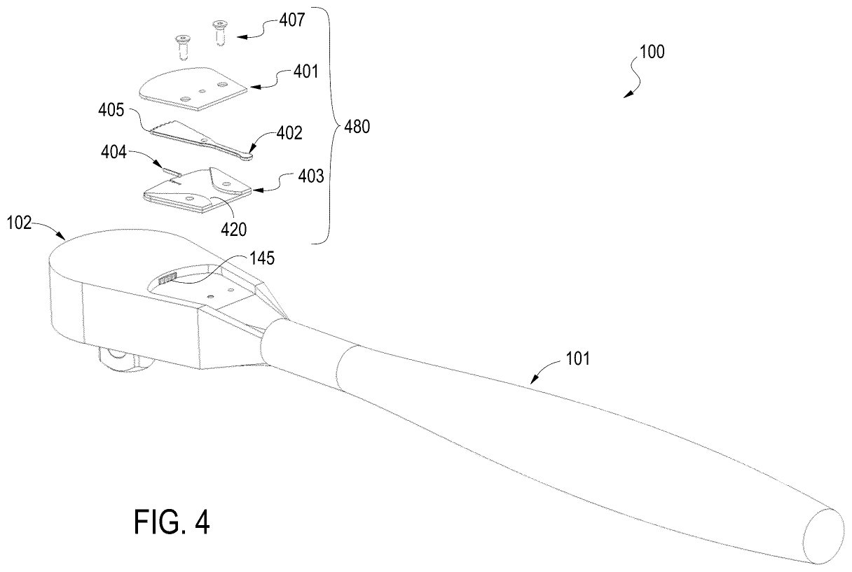

FIG. 4 is an exploded view of a lever direction selection mechanism 480 of the socket wrench 100. The lever direction selection mechanism 480 comprises a lever 402, base plate 403 and cover plate 401. In this embodiment, the direction of rotation of the socket wrench engagement is controlled via the lever 402. In this regard, the lever 402 is mounted to the head 102 via a base plate 403, which guides the lever 402 in a channel 420, and a cover plate 401 that secures the lever 402 to the head 102. In one embodiment, the lever direction selection mechanism 480 is secured via screws 407.

The lever 402 comprises a plurality of teeth 405. The teeth engage teeth 145 on the selector 104 (FIG. 1A). When the lever 402 is actuated, the selector 104 is rotated in a direction that controls the drive direction of the socket wrench 100, as described with referent to FIG. 3.

In one embodiment, the gearless socket wrench 100 comprises a thin metal finger 404. The finger 404 serves to provide auditory feedback to the user (not shown), that is customary in conventional socket wrenches. The finger 404 provides no function in use of the socket wrench 100 other than the auditory feedback. In this regard, the finger 404 interfaces with teeth 145 of the selector 104 to produce the auditory feedback when the handle is moved in the non-drive direction or the backstroke of the arcuate motion.

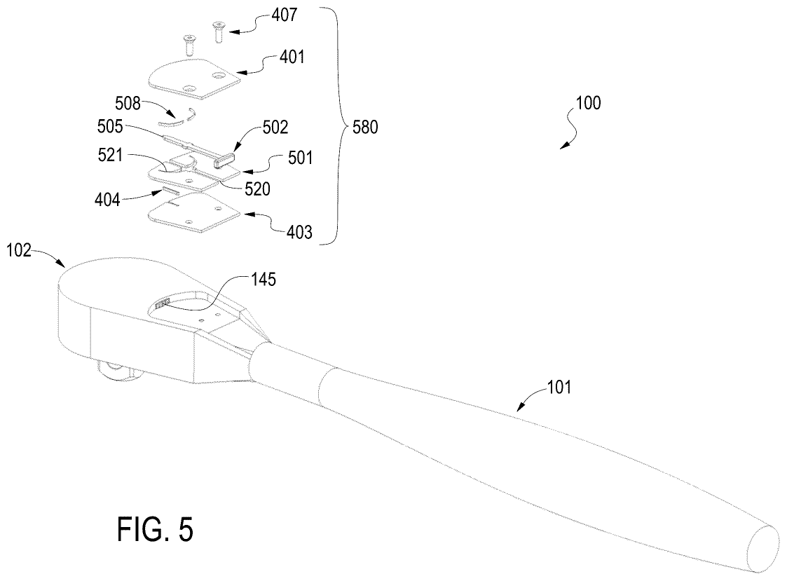

FIG. 5 is an exploded view of a button direction selection mechanism 580 of the socket wrench 100. The button direction selection mechanism 580 comprises a button 502, base plate 403, body plate 501, and cover plate 401. In this embodiment, direction of rotation of the socket wrench engagement is controlled via the button 502. In this regard, the button 502 is mounted to the head 102 via a base plate 403, a body plate 501, and a cover plate 401 that secures the button 502 to the head 102. In one embodiment, the button direction selection mechanism 580 is secured via screws 407.

In one embodiment, the body plate 501 comprises a channel 520 for receiving the button 502, and lateral arch-shaped channels 521 for retaining springs 508 for spring loading the button 502.

A tooth 505 of the button 502 engage teeth 145 on the selector 104 (FIG. 1A). When the button 502 is depressed, the selector 104 can be held fixed relative to the handle which when rotated relative to the collector in a direction will change the drive direction of the socket wrench 100, as described with referent to FIG. 3.

In one embodiment, the gearless socket wrench 100 comprises a thin metal finger 404. The finger 404 serves to provide auditory feedback to the user (not shown), that is customary in conventional socket wrenches. The finger 404 provides no function in use of the socket wrench 100 other than the auditory feedback. In this regard, the finger 404 interfaces with teeth 145 of the selector 104 to produce the auditory feedback when the handle 101 is moved in the non-drive direction or the backstroke of the arcuate motion.

1. A gearless socket wrench comprising:
a handle configured to receive user input;
a head integrally formed with or coupled to the handle, the head configured to engage a socket for a fastener;
a selector disposed within the head, the selector configured to control a drive direction of the fastener;
a force transmission member disposed within the head, the force transmission member configured to transmit torque to the fastener in coordination with the selector; and
a drive selection mechanism operatively connected to the selector, the drive selection mechanism configured to adjust the selector to select between a first drive direction and a second drive direction.

2. The gearless socket wrench of claim 1, wherein the head is integrally formed with the handle as a single monolithic structure.

3. The gearless socket wrench of claim 1, wherein the head is detachably coupled to the handle.

4. The gearless socket wrench of claim 1, wherein the drive selection mechanism includes at least one of a button, a lever, a switch, or a dial.

5. The gearless socket wrench of claim 1, further comprising a socket retention mechanism configured to releasably secure a socket to the head, wherein the head defines an aperture through which the socket retention mechanism is accessible.

6. The gearless socket wrench of claim 1, wherein a top portion of the head includes a cover configured to enclose at least a portion of the selector and the force transmission member.

7. The gearless socket wrench of claim 1, wherein the selector includes at least one engagement feature configured to interact with the drive selection mechanism to facilitate drive direction control.

8. The gearless socket wrench of claim 1, wherein the selector includes at least one engagement feature configured to interact with a feedback mechanism configured to provide at least one of auditory or tactile feedback in response to operation of the wrench in non-drive direction.

9. A method of operating a gearless socket wrench, comprising:
providing the gearless socket wrench of claim 1;
actuating the drive selection mechanism to adjust the selector to a first drive direction;
applying torque via the handle to engage a fastener in the first drive direction.

10. A method of operating a gearless socket wrench, comprising:
providing the gearless socket wrench of claim 1; actuating the drive selection mechanism to adjust the selector to a second drive direction; applying torque via the handle to engage a fastener in the second drive direction.
